(19) United States
(12) Patent Application Publication
(10) Pub. No.: US 2006/0215032 A1
(43) Pub. Date: Sep. 28, 2006

(54) NETWORK-BASED BROADCAST SYSTEM AND METHOD

(76) Inventor: Hans P. Bristell, Ventura, CA (US)

Correspondence Address: SHIPLEY LAWSON & JACOB, LLC, 324 E. 11TH ST., SUITE 101, KANSAS CITY, MO, 64106, US

(21) Appl. No.: 10/907,291

(22) Filed: Mar. 28, 2005

(51) Int. Cl. H04N 5/232; H04N 5/225

(52) U.S. Cl. 348/207.1; 348/211.12; 348/211.1

(57) ABSTRACT

A network-based system for delivering broadcast content to at least one user across a network includes an OB unit, a production studio and a preferably photonic network. The preferred system further includes means to convert and combine video and audio signals into a multi-channel optical signal, and means to split the multi-channel signal and modify the component signals at the production studio.

### BACKGROUND OF THE INVENTION

1. Field of the Invention

The present invention relates generally to audio/video broadcast systems, and more specifically, to a network-based broadcast system for production of audio/video content.

2. Discussion of Prior Art

Conventional live broadcast systems have been developed by the content/delivery industries to transmit audio and video content to viewers. These systems include at least one on-site field unit (OB unit) that travels to a target site, and a production studio for receiving and further modifying and controlling an intermediate OB unit signal to produce the final content. The interconnection between the OB unit and studio typically relies on electrical conduits and wireless communication, such as terrestrial shortlink and satellite transmission. The OB unit includes a plurality of manually operated cameras and microphones that each provide a separate signal to a central location within the OB unit. To modify and physically combine these signals into transmission-ready formats at the central location in the OB unit, a plurality of sound technician and vision production personnel are also required to travel with the OB unit, making conventional live OB broadcast systems labor intensive. The excessive equipment (i.e. a complete studio), associated with intermediate production further reduces the mobility of these systems, thereby resulting in added relocation costs and inconvenience during travel.

Conventional Internet network-based systems for streaming audio/video content to an end-user have been developed and require fewer personnel to operate. These systems typically store and make available to authorized users a downloadable or executable file of audio/video content. These streaming systems, however, are limited to previously recorded content. Conventional “web-cam” video and telecommunication technology have also been developed to enable the transmission of an unproduced virtually live video and/or audio signal across a network. Where the network is in place, this technology requires minimal equipment relocation. However, these systems do not in comparison to a produced content enable the compilation of multiple signals, modification of signal attributes, or the addition of appurtenances, indicia or graphics prior to or at the transmission. As such, these web-cam systems are unsuitable for conventional broadcasting.

### SUMMARY OF THE INVENTION

Responsive to these and other problems caused by conventional broadcast systems and network-based systems, the present invention concerns an improved system, it defines two independent networks a production network (FIG. 1) and a delivery network (FIG. 6), and a method for contribution of program content between production facilities across a production network.

Among other things, the invention is useful for reducing the costs associated with conventional broadcast systems. More particularly, the invention utilizes advancement in workspace technology, and in telecommunication technology to address a long-felt need of reducing the labor and equipment necessary to operate a live broadcast system.

A first aspect of the present invention concerns a broadcast system adapted for delivering content from a remote site to at least one user across a network, so as to define a network path. The system comprises an onsite broadcasting unit including a plurality of cameras, wherein each camera is configured to capture an image at the site and to generate a video signal, and a production studio communicatively coupled to the unit and users, and configured to produce the content from the video signals. The unit, users and studio are interconnected by the network.

A second aspect of the present invention concerns a method of broadcasting content to at least one user across a network. The method includes the steps of producing a plurality of video signals at a first general location, combining the video signals into a single multi-channel signal at the first general location, transmitting the single multi-channel signal to a second location across the network, wherein the multi-channel signal is split and the video signals are modified to produce the content, and delivering the content to the user across the network within a period from said production of the video signals, so as to define a network path.

Thus, the invention is further useful for acquiring a plurality of images and sounds at an OB unit, transporting the unrefined signal to a main studio for finalization and production, and delivering the final content to an end-user across an existing delivery network.

Other aspects and advantages of the present invention will be apparent from the following detailed description of a preferred embodiment(s) and the accompanying drawing figures.

### BRIEF DESCRIPTION OF THE DRAWING FIGURES

A preferred embodiment of the invention is described in detail below with reference to the attached drawing figures, wherein:

FIG. 1 is a schematic diagram of the system in accordance with a preferred embodiment of the present invention, particularly illustrating a redundant configuration wherein both photonic and conventional networks are connected and alternatively utilized;

FIG. 2 is a schematic diagram of an OB unit in accordance with a preferred embodiment of the present invention, particularly illustrating OOO network compatibility;

FIG. 3 is a schematic diagram of an OB unit in accordance with a preferred embodiment of the present invention, particularly illustrating OEO network compatibility;

FIG. 4 is a schematic diagram of a production studio in accordance with a preferred embodiment of the present invention, particularly illustrating OOO network compatibility;

FIG. 5 is a schematic diagram of a production studio in accordance with a preferred embodiment of the present invention, particularly illustrating OEO network compatibility; and

FIG. 6 is a schematic diagram of the delivery network system in accordance with a preferred embodiment of the present invention, particularly illustrating IP Multicast Distribution.

### DETAILED DESCRIPTION OF A PREFERRED EMBODIMENT OF THE INVENTION

The following detailed description of the embodiments of a system and methods of the present invention, as represented in the Figures, is not intended to limit the scope of the invention, as claimed, but is merely representative of presently preferred embodiments of the invention. It will be readily understood that the components of the present invention may be arranged and designed in a wide variety of different arrangements.

The Figures include schematic block diagrams, which illustrate in more detail preferred embodiment(s) of the present invention. The illustrated embodiments include certain modules for performing various functions of the present invention on a network-based system. As such, the represented modules include therein executable and operational data for operation within a computer processor. It is well within the ambit of the present invention, however, to utilize other interactive devices, such as smart phones, PDA's, and Laptop or TV set top boxes at the end-user stations.

I. Network-Based Broadcast System Configuration:

The system 10 includes at least one novel onsite broadcasting unit (OB unit) 12, a novel mixing, production and broadcast studio, i.e. production studio 14, and an interconnection network 16. More preferably, the system 10 includes a plurality of OB units 12, and the main studio 14 is configured so that the units 12 are able to communicate concurrently therewith. The preferred system 10 is configured to deliver final content through audio, video and/or data transmission to a plurality of users (not shown) over a network path. The preferred network 16 may comprise a wide area network (WAN), a local area network (LAN), and more preferably presents an optical-electrical-optical (OEO) network or interconnected system of networks, such as the World Wide Web network, i.e. Internet. Different communication protocols may be used on the network 16, but in the case of the Internet, a single layered communications protocol (TCP/IP) generally enables communications between the differing networks and stations.

More preferably, however, the network 16 presents an all-optical format transparent or photonic (OOO) network including photonic switching, so that the requirement to convert data into an electronic format prior to switching and back to optical after switching (see, FIG. 1) is eliminated. It is appreciated by those ordinarily skilled in the art that a photonic network includes a plurality of optical amplifiers that enable the network to span terrains and distances not previously possible by OEO networks. Most preferably, the network 16 utilizes “smart” photonic switching and calibration means that enable the automatic determination of the most efficient available network path, so as to optimize delivery time. It is further appreciated that utilizing an OOO network reduces delivery time by maintaining optical line speeds, bandwidth and increasing flexibility in application. Thus, the following description of the preferred system components will be made with respect to an OOO network 16.

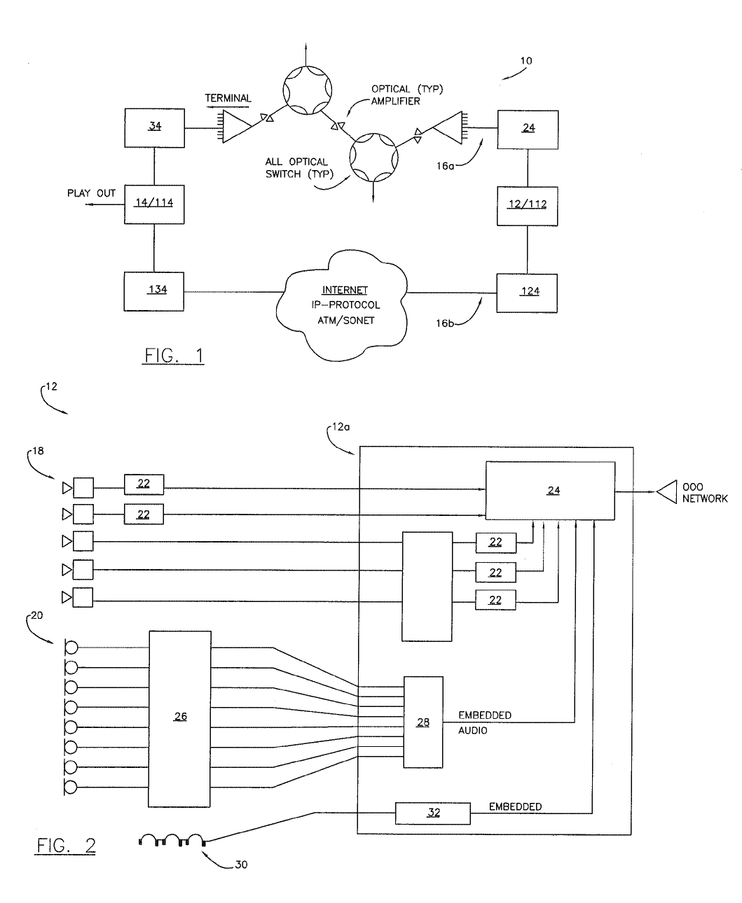

As shown in FIG. 2, each OB unit 12 includes at least one camera 18 and preferably at least one microphone 20. More preferably, each unit 12 includes pluralities of cameras 18 and microphones 20, wherein each camera 18 and microphone 20 is manually controlled by an operator (not shown). Most preferably, however, a portion of said plurality of cameras is robotically controlled at a central location 12a, such as a conventional broadcasting truck. Each camera 18 is connected in series to a transceiver 22 also preferably located within the central location 12a. Functionally, each camera 18 preferably presents an industry grade digital camera, such as the DVCPRO/DVCPRO HD, manufactured by Panasonic. The preferred cameras 18 provide uncompressed standard or high definition resolution feeds to the transceiver 22.

The transceiver 22 converts the camera signal from the electrical domain to the optical domain and sends the optical video signal to a Dense (i.e., Coarse) Wavelength Division Multiplexer (DWDM) 24 also preferably located within the central location 12a via an optical fiber. Suitable transceivers for use with a preferred embodiment of the present invention are HD/SDI & Analog Fiber Optic Camera transceivers, several of which are commercially available under the Copperhead Series from Telecast-Fiber Systems, Inc. of Worcester, Mass. A suitable DWDM is commercially available from Telecast-Fiber Systems, Inc. of Worcester, Mass. under the Diamondback Series. It is appreciated that the distance span between the transceiver 22 and DWDM 24 can be up to 20 kilometers.

Each of the mono and B-format ambience microphones 20 is preferably connected in sequential series to a conventional microphone amplifier 26, and a Dolby-E unit 28 that embeds the separate audio feeds into one embedded audio signal, and then to the DWDM 24. A suitable microphone for use with a preferred embodiment of the present invention is a Soundfield B-format microphone, and is commercially available under Soundfield Ltd. from Bakersfield of England.

Finally, the preferred OB unit 12 includes at least one headset receiver 30, and more preferably a plurality of headset receivers, i.e. party line, that is fed by a conventional intercom 32. A duplex line connects from the intercom 32 and through the DWDM 24, so that the operator of each headset receiver is able to communicate with a third party at the production studio. Further means, are also provided to enable communication between the operators at the central location 12a and the camera and microphone operators.

At the DWDM 24 the separate camera signals, embedded audio signal, and embedded party line signal are combined in the optical domain into a single multi-channel optical signal and transported across the network 16 to the production studio 14. As previously mentioned, the network 16 preferably presents a photonic network, so that the single signal does not have to be converted to the electrical domain for switching during navigation. It is appreciated that the photonic switching also provides a format transparent transmission with greater capacity, i.e. 10 terabit of uncompressed data bandwidth, than does conventional electrical switches.

At the production studio 14 the single multi-channel optical signal is transceived (i.e. converted) back from optical to electrical domain and to its original digital video and/or audio format. Wherein conventional OB units the program creation team i.e. producer, scriptgirl, technical operation manager (TOM), vision mixer, tape operator, graphic operator, video editor, camera operators, grip and audio mixer are located in the OB unit, a novelty of the present invention is the dividing of the program creation team. At the OB unit the acquisition team operates, i.e. camera operators and grip, while the creation team is relocated to the production studio 14, i.e. producer/vision mixer, audio mixer and program preparation operator.

The relocated creative team in the production studio 14 combines and modifies the attributes of the plurality of video and audio signals, including their format, appearance, amplitude, and accessibility, so as to produce a final deliverable content therefrom. The preferred studio 14 of the present invention, however, also includes novel aspects that enable connection to the network 16. It is also within the ambit of the present invention, for the studio 14 and unit 12 to be combined at one general location, where the final deliverable content is produced and delivered to the end-user across the network 16.

More particularly, and as shown in FIG. 4, the preferred production studio 14 includes a DWDM 34 operable to split the single multi-channel optical signal into its constituent components, i.e. the optical video signals, the combined embedded audio signal and the two-way embedded intercom signal in the illustrated embodiment. From the DWDM 34, one of a plurality of transceivers 36 receives a separate one of the optical video signals and converts it back to the electrical domain prior to entering a vision mixer 38. Also inputted into the vision mixer 38 are graphics produced by a computer graphics workstation module 40. At the vision mixer 38, the combined inputs are mixed by the program team to create a final produced video content that is delivered in a single feed to a master control portion 42 of the studio 14, and more particularly to a vision master control sub-portion 44.

In the illustrated embodiment shown in FIG. 4, the vision master control 44 also receives finalized content from other program creation teams 46, and therefore a single master control 42 controls play out for a plurality of contribution program generators. It is certainly well within the ambit of the present invention, however, to provide separate controls for each program.

The preferred studio 14 also includes a Dolby-E unit 48 for receiving the embedded audio signal. The product of the Dolby-E unit is transmitted to a sound mixer 52 to produce an unmodified sound content that is further transmitted to a sound master control sub-portion 50. Like the vision master control, the sound master control 50 receives inputs from the other program teams 46. Finally, the preferred studio 14 also includes an intercom 54 that delivers to and receives from the OB unit 12 embedded intercom signals. A plurality of expansion panel receivers 56 connected to the studio intercom 54 are utilized by the program team to communicate with the OB unit 12.

The preferred master control 42 further includes an embedder unit 58 for embedding final sound into the video signal provided by the vision and sound master control sub-portions 44 and 50, a compressor/data converter 60, such as an MPEG-4 coder, to preferably convert the products into a desired delivery format, and a streaming server 64 that delivers the content to the end-user. Thus, distribution of the program content is preferably in MPEG-4 CODEC format.

The content is delivered to the end-user across the network 16, with the understanding that the network 16 may consist of two separate sub-networks for production and delivery. More preferably, the content is delivered to the end-user220 by conventional multicasting technology that utilizes a router (or rendezvous point) 66 to communicate with the streaming server and selectively deliver content to authorized end-users only. This service may be performed by a Content Delivery Provider, as shown in FIG. 6. The preferred multicasting technology utilizes a group management protocol that establishes and maintains multicasting groups, and multicast routing protocols to route packets efficiently. It is appreciated that the efficiencies provided by multicasting reduce network traffic and therefore real time delivery, by contributing only authorized and targeted content to the network 16.

The DRM management is more preferably outsourced and contracted to the content delivery provider as an integration of the Multicasting process and regulated and controlled by B2B in e-commerce transactions.

II. Redundancy OEO Network System:

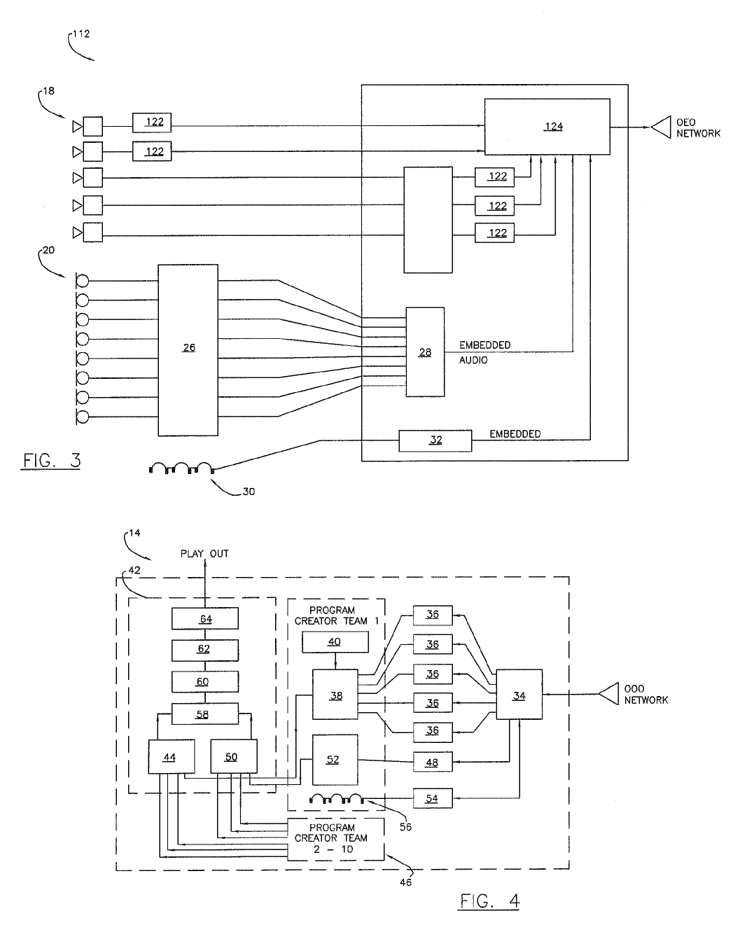

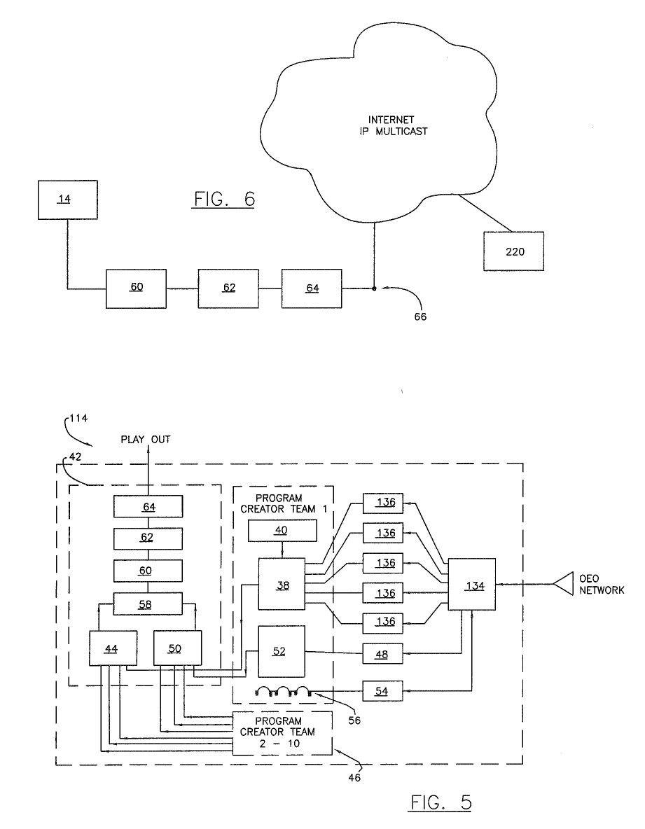

Alternatively, so as to interconnect with an OEO network by a redundancy switch-over apparatus, the system 10 includes an OB unit 112 that preferably incorporates at least one MPEG-4 codec 122 in lieu of the transceivers 22 (see, FIG. 3). The MPEG-4 codec provides compressed video signal to a Time Division Multiplexer (TDM) 124 in lieu of the DWDM 24. It is appreciated by those skilled in the art that MPEG-4 AVC provides audio and video compression, enabling the distribution of content and services from low bandwidths to high-definition quality across, broadband, wireless and packaged media. In this alternative embodiment, a production studio 114 is likewise provided that replaces the transceivers 36 with MPEG-4 Decoders 136 and the DWDM splitter 34 with a TDM splitter 134 (see, FIG. 5).

As shown in FIG. 1, where OEO and OOO networks are available, i.e. during a transition period, the system 10 more preferably includes both OB units 12, 112, and main studios 14, 114. The OOO and OEO networks 16a-b both interconnect the units 12, 112 and studios 14, 114 but are not simultaneously active.

Instead the OEO unit 112, studio 114 and network 16b are activated via a switchover system upon the failure of any one of the OOO system components. In this regard, the OOO network 16a, OB unit 12 and main studio 14 serves as the primary system, while the OEO network 16b, OB unit 112, and main studio 114 serve as a redundancy or backup system.

For both configurations, it is appreciated that distribution networks peripheral to system 10, such as Internet OEO and peered wireless networks can be utilized to navigate local traffic and complete delivery to the end-users Mobile Video Device MVD. More preferably, where a wireless peripheral network is utilized to complete delivery to a device, the wireless network technology presents broadband-speed service. For example, a suitable wireless network technology for use with the present invention is commercially available as EV-DO (Evolution, Data Only) i.e. mobile smart phone, from Sprint Corporation of Overland Park, Kans. Utilization of broadband metropolitan Wi Max network (80 Mbit) or a virtual private network (VPN) is also well within the ambit of the present invention, where the target audience is limited to a locality.

Another aspect of the present invention utilizes the network 16 to send and receive data to and from the end-user.

III. System Methodology:

Thus, a method of using the system 10 as described in the illustrated embodiment to deliver broadcast content to at least one user includes the following steps. The method starts at a first step in which a plurality of video and preferably audio signals are captured at a first general location. At a second step the signals are combined into a single multi-channel signal at the first general location. The single multi-channel signal is transmitted to a second location, wherein the multi-channel signal is split and the video signals are modified to produce the content. At a third and final step the content is transmitted to the user across the network within a period not greater than five minutes from the production of the video signals.

More preferably, at the first step the video signals are converted into optical video signals and the audio signals are combined into a single embedded audio signal prior to combining the signals into a single multi-channel signal at the first location. The multi-channel signal is preferably transmitted across a “smart” photonic network to the second location, where the optical signals are converted back to video signals. At the third step the content is preferably transmitted to the user across the photonic network within a period not greater than 30 seconds from the production of the video signals, and most preferably within a period of 3 video frames or 100 mS. Most preferably, the method further includes a duplex intercom line between the unit and studio, wherein the line further comprises the multi-channel signal.

Obvious modifications to the exemplary embodiments and methods of operation, as set forth herein, could be readily made by those skilled in the art without departing from the spirit of the present invention. As used herein, the term “plurality” shall mean two or more. The inventor hereby states his intent to rely on the Doctrine of Equivalents to determine and assess the reasonably fair scope of the present invention as pertains to any system not materially departing from but outside the literal scope of the invention as set forth in the following claims.

What is claimed is:

1. A broadcast system adapted for delivering content from a remote site to at least one user across a network, said system comprising:
an onsite broadcasting unit including a plurality of cameras, wherein each camera is configured to capture an image at the site and to generate a video signal; and
a production studio communicatively coupled to the unit and user, and configured to produce the content from the video signals,
said unit, user and studio being interconnected by the network.

2. The system as claimed in claim 1, wherein a portion of the plurality of cameras are robotically controlled.

3. The system as claimed in claim 1, said unit being configured to convert each video signal into an optical video signal.

4. The system as claimed in claim 3,
said unit being further configured to combine the optical video signals into a single multi-channel signal,
said studio being configured to split the single multi-channel signal into its component audio and optical video signals.

5. The system as claimed in claim 4,
each of said unit and studio further including a Dense Wavelength Division Multiplexer.

6. The system as claimed in claim 1,
said unit further including a plurality of microphones, wherein each microphone is configured to capture sound at the site and generate an audio signal,
said studio being configured to produce the content from the audio and video signals.

7. The system as claimed in claim 6,
said unit being further configured to combine the audio signals into a single embedded audio signal, and combine the single embedded audio signal and video signals into a single multi-channel signal.

8. The system as claimed in claim 7,
said unit further including a plurality of receivers and an intercom, wherein said receivers and intercom are cooperatively configured to generate and receive an embedded intercom signal,
said unit being further configured to combine the embedded intercom, embedded audio, and video signals into a single multi-channel signal,
said studio being further configured to split the single multi-channel signal into the embedded intercom, embedded audio, and video signals.

9. The system as claimed in claim 1, wherein each of the video signals are compressed and combined into a single multi-channel transmission signal at the unit, and the single multi-channel transmission signal is split and decompressed back to the video signals at the studio.

10. The system as claimed in claim 9,
said unit further including an MPEG encoder operable to compress the video signals into the transmission signals, and a Time Division Multiplexer operable to combine the individual transmission signals into the single multi-channel transmission signal,
said studio further including a Time Division Multiplexer operable to split the single multi-channel transmission signal into individual transmission signals, and an MPEG decoder operable to decompress the transmission signals.

11. The system as claimed in claim 1,
said studio including a program creation module configured to modify the video signals and produce the final content,
said studio further including a computer graphics component for adding computer imagery to the video signals and a vision mixer component for combining and modifying the video signals.

12. The system as claimed in claim 11,
said studio being further configured to embed and compress the content into a content deliverable format.

13. The system as claimed in claim 12,
said studio further including an MPEG-4 encoder operable to compress the content into the content deliverable format.

14. The system as claimed in claim 13,
said studio further including a streaming server configured to receive the content in the content deliverable format and deliver the same to at least one user.

15. The system as claimed in claim 1,
said network including separate production and delivery sub-networks.

16. The system as claimed in claim 1,
said unit, studio and network being cooperatively configured to deliver the content to the at least one user within five minutes from the production of the video signals.

17. The system as claimed in claim 16,
said unit, studio and network being cooperatively configured to deliver the content to the at least one user within 30 seconds.

18. An onsite broadcasting unit adapted for delivering a multi-channel signal across a network, said unit comprising:
a plurality of cameras, wherein each camera is configured to capture an image and generate a video signal, so as to produce a plurality of signals;
a mechanism adapted to modify the signal;
a mechanism adapted to combine the plurality of signals into the multi-channel signal; and
a mechanism adapted to deliver said multi-channel signal to the network.

19. The unit as claimed in claim 18, wherein a portion of the plurality of cameras are robotically controlled.

20. The unit as claimed in claim 18,
said mechanism adapted to modify the signal being further adapted to convert each video signal into an optical video signal,
said mechanism adapted to combine the plurality of signals including a Dense Wavelength Division Multiplexer.

21. The unit as claimed in claim 18; and
a plurality of microphones, wherein each microphone is configured to capture sound and generate an audio signal; and
a mechanism adapted to combine the audio signals into a single embedded audio signal, and combine the single embedded audio signal and video signals into the single multi-channel signal.

22. The unit as claimed in claim 21; and
a plurality of receivers and an intercom, wherein said receivers and intercom are cooperatively configured to generate and receive an embedded intercom signal;
a mechanism adapted to combine the embedded intercom, embedded audio, and video signals into a single multi-channel signal.

23. The unit as claimed in claim 18,
said mechanism adapted to modify the signals including an MPEG encoder operable to compress the video signals into transmission signals,
said mechanism adapted to combine the signals including a Time Division Multiplexer operable to combine the individual transmission signals into the single multi-channel signal.

24. A production studio adapted for receiving a multi-channel signal across a network, said studio comprising:
a mechanism adapted to split the multi-channel signal into a plurality component signals;
a plurality mechanism adapted to modify the component signals;
a computer graphics module operable to add graphics to the component signals; and
a master control module operable to compress the component signals into a final delivery format.

25. The studio as claimed in claim 24,
said mechanism adapted to split the multi-channel signal including a Dense Wavelength Division Multiplexer,
each of said plurality of mechanisms adapted to modify the component signals including a transceiver.

26. The studio as claimed in claim 24,
said mechanism adapted to split the multi-channel signal including a Time Division Multiplexer
each of said plurality of mechanisms adapted to modify the component signals including an MPEG decoder operable to decompress the component signals.

27. The studio as claimed in claim 24,
said master control module including an MPEG-4 encoder.

28. A method of broadcasting content to at least one user across a network, said method comprising the steps of:
(a) producing a plurality of video signals at a first general location;
(b) combining the video signals into a single multi-channel signal at the first general location;
(c) transmitting the single multi-channel signal to a second location, wherein the multi-channel signal is split and the video signals are modified to produce the content; and
(d) delivering the content to the user across the network within a period not greater than five minutes from said production of the video signals.

29. The method as claimed in claim 28,
steps (a) and (c) further including the steps of converting the video signals into optical video signals at the first location, delivering the content across a photonic network, and converting the optical signals back to video signals at the second location.
